(19) United States
(12) Patent Application Publication
(10) Pub. No.: US 2019/0143517 A1
(43) Pub. Date: May 16, 2019

(54) SYSTEMS AND METHODS FOR COLLISION-FREE TRAJECTORY PLANNING IN HUMAN-ROBOT INTERACTION THROUGH HAND MOVEMENT PREDICTION FROM VISION

(71) Applicants: Yezhou Yang, Tempe, AZ (US); Wenlong Zhang, Mesa, AZ (US); Yiwei Wang, Tempe, AZ (US); Xin Ye, Tempe, AZ (US)

(72) Inventors: Yezhou Yang, Tempe, AZ (US); Wenlong Zhang, Mesa, AZ (US); Yiwei Wang, Tempe, AZ (US); Xin Ye, Tempe, AZ (US)

(73) Assignee: Arizona Board of Regents on Behalf of Arizona State University, Tempe, AZ (US)

(21) Appl. No.: 16/190,750

(22) Filed: Nov. 14, 2018

Related U.S. Application Data
(60) Provisional application No. 62/585,791, filed on Nov. 14, 2017.

(51) Int. Cl. B25J 9/16; G06K 9/00; G06N 3/04; G06N 3/08; G06N 5/04

(52) U.S. Cl. CPC B25J 9/1666; B25J 9/1697; B25J 9/163; G06N 5/046; G06N 3/0454; G06N 3/08; G06K 9/00355

(57) ABSTRACT

Various embodiments of systems and methods for collision-free trajectory planning in human-robot interaction through hand movement prediction from vision are disclosed.

### CROSS REFERENCE TO RELATED APPLICATIONS

This is a non-provisional application that claims benefit to U.S. provisional application Ser. No. 62/585,791 filed on Nov. 5, 2018, which is herein incorporated by reference in its entirety.

### FIELD

The present disclosure generally relates to a collision-free trajectory planning in human-robot interaction, and in particular to systems and methods for collision-free trajectory planning in human-robot interaction through hand movement prediction from vision.

### BACKGROUND

Modern household and factory robots need to conduct collaborative manipulation with human users and workers. They not only need to finish their manipulation tasks but also need to maximize their chance of success while human users are collaborating with them. For example, under a factory scenario, autonomous robots are good at conducting repetitive and accurate manipulations, such as hammering a nail, while they face challenges with tasks such as pinch a nail from a box of unsorted ones. In such case, assistance from human workers becomes crucial. However, with the human in the loop, the robot controller has to take the human motion into consideration while planning an optimal trajectory to avoid collision and ensure safety.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an illustration showing an embodiment of the hand movement prediction model, according to aspects of the present disclosure;

FIG. 2 is a simplified block diagram showing the structure of the entire system for safe HRI, according to aspects of the present disclosure;

FIGS. 3A-3C are pictures illustrating the performed actions of drinking, cutting, and pounding, respectively, according to aspects of the present disclosure;

FIG. 4A is a graphical representation of average RMSE of dx and FIG. 4B is a graphical representation of average RMSE of dy, according to aspects of the present disclosure;

FIG. 5 is an illustration showing a sequence of pictures providing an example of hand movement prediction result, according to aspects of the present disclosure;

FIG. 6A is an illustration showing an experiment without human motion prediction and FIG. 6B is an illustration showing the experiment with human movement prediction, according to aspects of the present disclosure;

FIG. 7 is a picture illustrating an experimental setup, according to aspects of the present disclosure; and

FIG. 8A is a picture showing robot gripper trajectories of experiments without human motion prediction and FIG. 8B is a picture showing robot gripper trajectories with human motion prediction, according to aspects of the present disclosure.

FIG. 9 illustrates a block diagram of the system, according to aspects of the present disclosure.

Corresponding reference characters indicate corresponding elements among the view of the drawings. The headings used in the figures do not limit the scope of the claims.

### DETAILED DESCRIPTION

The present disclosure is motivated by observing two human workers collaborating with each other. First of all, each person is aware of the location of the other. Secondly, while human workers are conducting collaborative manipulation tasks, it is essential that each human can predict the other human's movement to avoid collision. Therefore, two major capabilities are involved in developing the robot controller of the present system: 1) a perception module that tracks and predicts the collaborator's movement, 2) an adaptive trajectory planning module that takes into consideration of the movement prediction and adjusts the robot manipulation trajectories. Moreover, these two capabilities need to be seamlessly integrated to enable real-time motion adaptation responses.

With the motion capture system, a system that can track the human collaborator's hand accurately is achieved with a price of attaching a marker on the human arm and hand. Moreover, the robot manipulator or human body is likely to block the marker during operation and leads to a failure of the motion capture system. The present disclosure aims at predicting human collaborator's hand movement from visual signal solely without markers. The main difficulty of implementing such a perception module lies in the huge amount of variations (such as illumination, hand poses, hand texture, object texture, manipulation pattern etc.) the system has to deal with. To tackle this difficulty, the Recurrent Neural Network architecture was adopted to enable a learning subsystem that learns the spatial-temporal relationships between the hand manipulation appearance with its next several steps of movements. To validate the effectiveness of the approach, experiments were first conducted on publicly available manipulation dataset. To further validate that the method can predict the movement with decent precision, a novel set of manipulation data with readings was captured from motion capture system to serve as the ground truth.

On the other hand, the vision based movement prediction module is inevitably less accurate than motion capture system. In such a case, traditional motion capture system based adaptive trajectory planning approach does not suffice. Thus, the inventors have developed a novel robot trajectory planning approach based on the safety index to reach its final destination and avoid collision. To validate the present motion planning module, two experiments were conducted. The present method was first tested on a simulation platform which takes the movement prediction from vision module as the input for trajectory planning. Then, using the Robot Operating System (ROS), a Universal Robot (UR5) was integrated that can collaborate with the human worker to avoid collisions.

Visual Movement Prediction: The problem of visual movement prediction has been studied from various perspectives, and there are a number of works that aim at predicting objects movements. For example, others have predicted pixel motion of physical object by modeling motion distribution on action-conditioned videos. In addition, others have trained a Convolutional and Recurrent Network on synthetic datasets to predict object movements caused by a given force. Physical understanding of objects motion is known to predict the dynamics of a query object from a static image. These works all focus on passive objects motion while the present disclosure is directed to predicting the movements of an active subject, i.e. the human hand. Some other works have previously addressed movement prediction problem as predicting optical flow, where they predicted motion of each and every pixel in an image. However, in the present case, there is only interest in human hand movement, while other pixel-level motions are ignored.

Visually predicting human movement is more relevant to the present disclosure, while such works are usually called action prediction or early event detection. These works include inferring future actions, especially the trajectories-based actions of people from noisy visual input also proposed a hierarchical representation to describe human movements and then used it as well as a max-margin framework to predict future action. Here, the hand movement prediction as a regression process is treated without predicting the actual action label. More recently, others have proposed to apply a conditional variational autoencoder based human motion prediction for human robot collaboration. However, they used pre-computed skeletal data instead of raw images.

Human motion prediction using other methods: Previous works have predicted human motion by using Gaussian Mixture Model to ensure safety in human-robot collaboration. However, what their system predicts is the workspace occupancy, and our system predicts hand movement directly. Previous works have used a multivariate Gaussian distribution based method to predict the target of the human reaching motion. Beyond simple reaching motion, much more complex motions during manipulation actions are considered, such as cutting. Others have trained an encoding-decoding network from motion capture database to predict 3D human motions. Again, motion capture system is not practical in the real human-robot collaboration scenario as described above.

Safety in Human-robot Interaction: The issue of generating a safe trajectory for a manipulator in human-robot interaction (HRI) has been studied for a long time, and many reported works focus on developing collision-free trajectories in HRI. Kulió and Croft defined a danger index approach to quantize the risk of safety in HRI by analyzing the relative distance and velocity between human and robot. Instead of quantifying the level of danger in HRI into a scalar index, a safety field was developed to generate a collision-free trajectory for a manipulator by Polverini. A collision-free trajectory design approach was previously introduced in based on distance estimation with a depth camera. A kinematic control strategy was developed to decide the robot joint speeds based on linear programming and it was applied in an ABB dual-arm robot. Tsai proposed a framework to generate collision-free trajectory by solving a constrained nonlinear optimization problem, and human motion was predicted based on the assumption of constant velocity. All the aforementioned works do not emphasize on predicting human motion, which requires the robot to take fast actions based on the current measurement or unreliable prediction. The present disclosure explores how to predict the human motion so that the robot trajectory planning can be proactive.

### Visual Movement Prediction

The goal of the proposed vision submodule is to predict human hand movement from visual input. Herein, only the video frames achieved from the camera mounted on the robot as input are taken. Without loss of generality, it is assumed that the human co-worker manipulates single object with one hand on a working plane. The video frames capture the human co-worker's hand manipulation.

To represent the hand movement from current frame to the next time step, we adopt a displacement measure (dx, dy), which is at pixel level. The present method uses a CNN-RNN-based model to predict human manipulation action type and forces signals. Here, a similar structure is adopted, but extend it to further predict manipulation movement. The learning method includes a pre-trained Convolutional Neural Network (CNN) model to extract visual features from a patch of image input, and a Recurrent Neural Network (RNN) model is trained to predict hand movement (dx, dy).

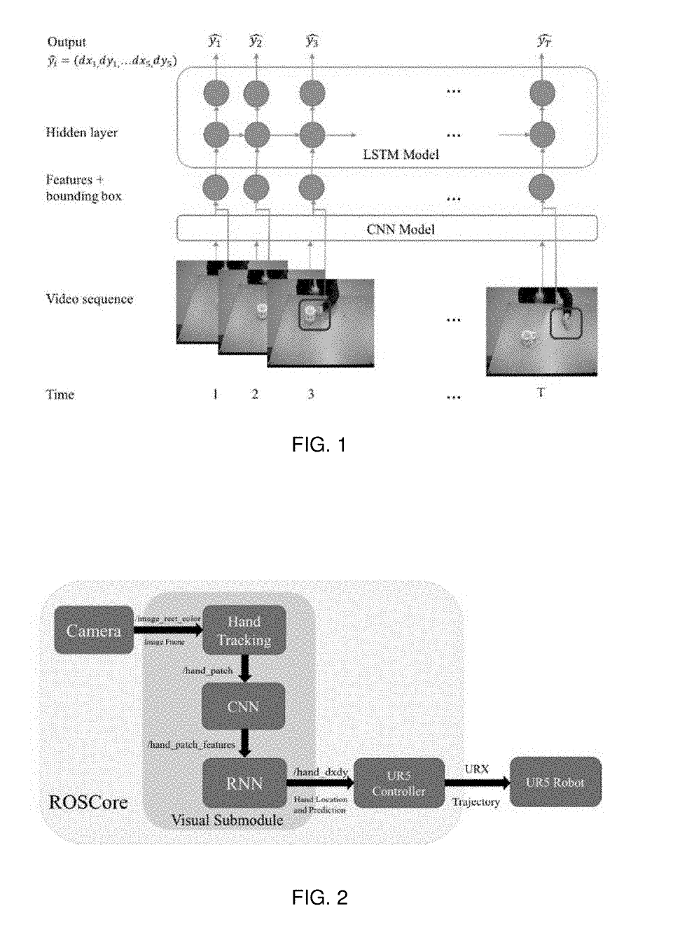

The overall visual submodule is depicted in FIG. 1 which describes different components in detail.

First, to monitor human hand movement and manipulation, the system needs an attention model to focus on human hand. Given a frame of human manipulation captured by the camera, our system focuses on small patch around the human hand. This makes sense because we as human beings pay attention to the co-worker's hand as we are interested in its movement. To achieve it, the present system tracks the human hand to get the corresponding bounding box of the hand at each frame. This method tracks human hand using the color distribution. Thus no additional information is required. Given the bounding box information, the present system crops an image patch centered around the human hand for each frame. Then, the present system treats such image patch as the input to the CNN model (the VGG 16-layer model is herein adopted), to extract feature representation. This preprocessing step provides a sequence of feature representations and their corresponding bounding boxes, which represents the position of the hand in the frames. The present system pipelines this sequence as the input to the RNN model.

The RNN model has recurrent connection in its hidden layer, which makes it suitable for modeling time-dependent sequences. However, since each hidden state stores all the history information from the initial state, it is extremely difficult to train the traditional RNN model with back-propagation algorithm, due to the vanishing gradient problem. Thus, the LSTM model is adopted, in which each hidden state selectively “forgets” some history information by introducing the mechanism of memory cells and gating.

The input of the LSTM model is denoted as a sequence X={x₁, x₂, . . . , x_{T}} In our case, xₜ here is the extracted feature vector of the hand patches at time t together with the corresponding hand bounding box as noted above. Then, by introducing memory cell cₜ, input gate iₜ, forget gate fₜ and output gate oₜ, the LSTM model computes the hidden state hₜ as follows:

iₜ=σ(Wₓᵢxₜ+Wₕᵢhₜ₋₁+bᵢ)

fₜ=σ(Wₓₜxₜ+W_{hf}hₜ₋₁+b_{f})

oₜ=σ(Wₓₒxₜ+Wₕₒhₜ₋₁+bₒ)

cₜ=fₜcₜ₋₁+iₜ tan h(W_{xc}xₜ+W_{hc}hₜ₋₁+b_{c})

hₜ=oₜ tan h(cₜ). (1)

Once hₜ is computed, we connect the final model output as the hand displacement (d\hat{x}, dŷ) at time t, which we denote here as ŷₜ:

ŷₜ=W_{hy}hₜ+b_{y}. (2)

During the LSTM training phase, we first compute the ground truth value of hand displacement Y={y₁, y₂, . . . , y_{T}} by estimating the hand position at each frame as the center point of the hand bounding box from the preprocessing step. Then, the loss function is defined as the squared distance between Ŷ and Y as shown in (3). The model is trained by minimizing this loss function with stochastic gradient decent (SGD) method:

$$L ( W . b ) = {\sum }_{t = 1}^{T} {‖ {\hat{y}}_{i} - {y}_{t} ‖}_{2}^{2} . \qquad ( 3 )$$

To assist the control submodule for planning a safer and smoother trajectory, the model is further extended to predict several further steps of the hand movement. Specifically, instead of just predicting the next one step in the future, during experiments the hand movement were predicted for the next five steps into the future, namely, ŷₜ=(d \hat{x}₁, dŷ₁, . . . d \hat{x}₅, dŷ₅). Once the LSTM model is trained, during the testing phase, the preprocessing step is pipelined with the trained model to predict the next five steps of the human hand movement in real time.

### Camera Calibration and Coordinate Alignment

From the last subsection of the paper, the predicted data are presented in pixel coordinates. It requires a coordinate transformation process that projects the camera pixel location to the Cartesian space where the robot is operated. The camera calibration and coordinate transformation process is modeled as follows [22],

$$\begin{matrix}[ \begin{matrix}{X}_{c} \\ {Y}_{c} \\ {Z}_{c}\end{matrix} ] = R [ \begin{matrix}{x}_{c} \\ {y}_{c} \\ {z}_{c}\end{matrix} ] + t & ( 4 ) \\ {x}_{c}^{′} = {x}_{c} \text{/} {z}_{c} & ( 4. a ) \\ {y}_{c}^{′} = {y}_{c} \text{/} {z}_{c} & ( 4. b ) \\ {x}_{c}^{″} = {x}_{c}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}_{c}^{′} {y}_{c}^{′} + 2 {p}_{2} ( {r}^{2} + 2 {x}_{c}^{′2} ) & ( 4. c ) \\ {y}_{c}^{″} = {y}_{c}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}_{c}^{′} {y}_{c}^{′} + 2 {p}_{2} ( {r}^{2} + 2 {y}_{c}^{′2} ) & ( 4. d )\end{matrix}$$

where

r²=x_{c}^{r2}+y_{c}^{r2}

u=fₓ*x_{c}^{″}+c^{x}

v=f_{y}*y_{c}^{″}+c_{y}

[u, v]^{T} represents a point in the coordinate of pixels, while [X_{c}, Y_{c}, Z_{c}]^{T} is its location in the robot operation Cartesian space. As the lens of camera usually has distortion, equations (4.c) and (4.d) are required to correct both the radical distortion and tangential distortion, where k₁, k₂, k₃, k₄, k₅ and k₆ are radial distortion coefficients. p₁ and p₂ are tangential distortion coefficients. These distortion coefficients belong to the intrinsic camera parameters, which can be determined by a classical black-white chessboard calibration process. [cᵣ, c_{y}] is the center pixel of the image. fₓ and f_{y} are the focal lengths in pixel units, which can be measured by the calibration process. R is the rotation matrix of the homogeneous transformation while t is the translation vector. They align the camera coordinates to the Cartesian space where the robot is operated. In this paper, the HRI scene is defined as the operations upon a table, where the Z direction is not concerned. The location [X_{c}, Y_{c}, Z_{c}]^{T} decays to a 2D vector [X_{c}, Y_{c}]^{T}.

Generate Space Occupation from Prediction

The human hand location and motion prediction data are projected from the pixel locations to the points in the table plane, where the robot is operated. The predicted human hand motion, denoted as ŷₜ=(d \hat{x}₁, dŷ₁, . . . , d \hat{x}₅, dŷ₅), and the current hand position yₜ=(x, y) form a vector Yₜ∈ [symbol] ⁿ where n=12, which presents the location and predicted future locations of human hand at time t, as Yₜ=[Yₜ, ŷₜ]^{T}.

In order to generate a collision-free trajectory, a mapping from the robot joint angle values to the space occupation of the table is defined as follows:

Rₜ(θₜ)={xₜ∈ [symbol] |xₜ∈RPₜ}, (5)

where θₜ∈ [symbol] ^{N} is the joint configuration of a manipulator at time t, while N is the degree-of-freedom of the manipulator. RPₜ represents the occupation of the robot body on the operation plane at time t. Another projection which presents the occupation of human hand at time t is defined as follows:

Hₜ(Yₜ)={xₜ∈ [symbol] ²|∥xₜ−yᵢ∥₂≤RMSEᵢ}, (6)

where yᵢ=[x+d \hat{x}ᵢ, y+dŷᵢ]^{T}=1, 2, . . . , 5. RMSEᵢ rep-resents the root-mean-square error (RMSE) at i^{th} predicted time step. Then, the most critical distance between these two 2D point sets is formed as follows,

$$CD ( {θ}_{t} , {Y}_{t} ) = {inf}_{{a}_{t} ∈ {H}_{t} , {b}_{t} ∈ {R}_{t}} {‖ {a}_{t} - {b}_{t} ‖}_{2} . \qquad ( 7 )$$

As equation (7) shows, the most critical distance between the robot manipulator and the human hand is formed as a function of the hand motion position, prediction data and the joint angle values of the manipulator. These factors describe whether the collision will happen between the human and the robot.

### Optimal Trajectory Generation

In this subsection, the optimization problem, which generates a collision-free trajectory for the manipulator, is carried out. The process we propose is inspired by Tsai's work on optimal trajectory generation. The objective of the optimization problem is to minimize the length of path towards the goal configuration which achieves the task, while the safety constraint is fulfilled. The optimization problem is formulated as follows:

θₜ₊₁∈ [symbol] ^{N} is the optimal variable at time t, where N is the degree-of-freedom of the manipulator, which stands for the joint angles for the manipulator at time t+1. The objective equation (8) minimizes the distance between the current robot configuration to its goal. As we define the operation space to be a plane upon a table, the goal configuration yields into a 2D vector x_{g}∈ [symbol] ². It means the desired robot end effector

$$\begin{matrix}{min}_{{θ}_{t + 1}} {‖ ( F ( {θ}_{t + 1} ) - {x}_{g} ) ‖}_{2} & ( 8 ) \\ s . t . {θ}_{t} ⋯ {\dot{θ}}_{max} T \leq {θ}_{t + 1} \leq {θ}_{t} + {\dot{θ}}_{max} T & ( 8. a ) \\ CD ( {θ}_{t + 1} , {Y}_{t} ) \geq Δ , & ( 8. b )\end{matrix}$$

which stands for the location of t
zation problem, where T i maximum angular speed of all the joints. Equation (8.b) is the safety constraint which ensures a collision-free trajectory, and A is the minimum distance between the robot end effector to the human hand to guarantee safety.

By solving this optimization problem iteratively at every time step of the system, a collision-free trajectory of the manipulator can be generated in real time, while achieving the goal of robot for task execution. The objective equation (8) ensures that the trajectory always tracks its goal while (8.a) and (8.b) guarantee the smooth and safe trajectory.

### System Integration for Real-Time Execution

The structure of the present system is demonstrated in FIG. 2, which enables real-time hand tracking, prediction and optimal collision-free trajectory generation. As FIG. 2 shows, the image is captured by an Xtion PRO LIVE RGBD camera from ASUS. The image frames are formatted and published to the ROS platform by Openni2 camera driver. The hand tracking node in ROS subscribes the image frames, recognizes the hand pattern and delivers the hand patch to the neural network nodes which are introduced herein. The CNN and RNN nodes generate a message vector, which contains the current hand location and predicted hand motion, and publish to ROS. A node named UR5 Controller subscribes the hand motion and prediction vector, solves the optimization problem, which is described herein, with sequential quadratic programming (SQP) solver from scipy optimization toolbox. The result of the optimization problem forms a command of the desired angular position of every joint on the UR5 manipulator. The UR5 Controller node communicate with UR5 robot via socket communication with the help from a Python package named URX, by which the desired angular position command is sent to UR5 where the command is executed.

### EXPERIMENTS

The theoretical and practical descriptions of the proposed system suggest three hypotheses that need empirical validation: a) the proposed vision module is able to predict human hand movement with reasonable accuracy; b) the proposed control module is able to plan a better robot movement trajectory to avoid collision during collaboration, given the hand movement prediction from the vision submodule; c) these two modules can be integrated together to enable a physical robot manipulator to collaborate with the human co-worker in a real-time fashion. To validate hypotheses (a) and (b), we conducted experiments on both publicly available and new data collected from our lab. To validate hypothesis (c), a robotic system was integrated within the ROS framework. The performance of the system was evaluated both in simulations and on an actual robot in experiments.

### Datasets

To validate the previous proposed hand movement prediction module, a test bed with various users conducting different manipulation actions with several objects was required. The recent work provides such a collection of human manipulation data. Though the purpose of their data is to validate manipulation action label and force prediction, the same set of actions contain significant amount of hand movements on a table plane. Thus, it also suits our need for training and validating the hand movement prediction module. The dataset includes side-view video recordings of five subjects manipulating five different objects with five distinct actions, and each is repeated five times (a total number of 625 recordings). Table I lists all object-action pairs. For further details about the public available dataset.

TABLE I
Object-action pairs in the public dataset

| Object | Action | |
|---|---|---|
| [symbol] st [symbol] | $RMSE = \sqrt{\frac{{\sum }_{i = 1}^{N} {\sum }_{t = 1}^{T} {( {\hat{y}}_{it} - {y}_{it} )}^{2}}{NT}}$ | (9) |
| sponge | squeeze, hip, wash, wipe, scratch | |
| spoon | scoop, stir, hit, eat, sprinkle | |
| knife | cut, chop, poke a hole, peel, spread | |

[symbol]

indicates data missing or illegible when filed

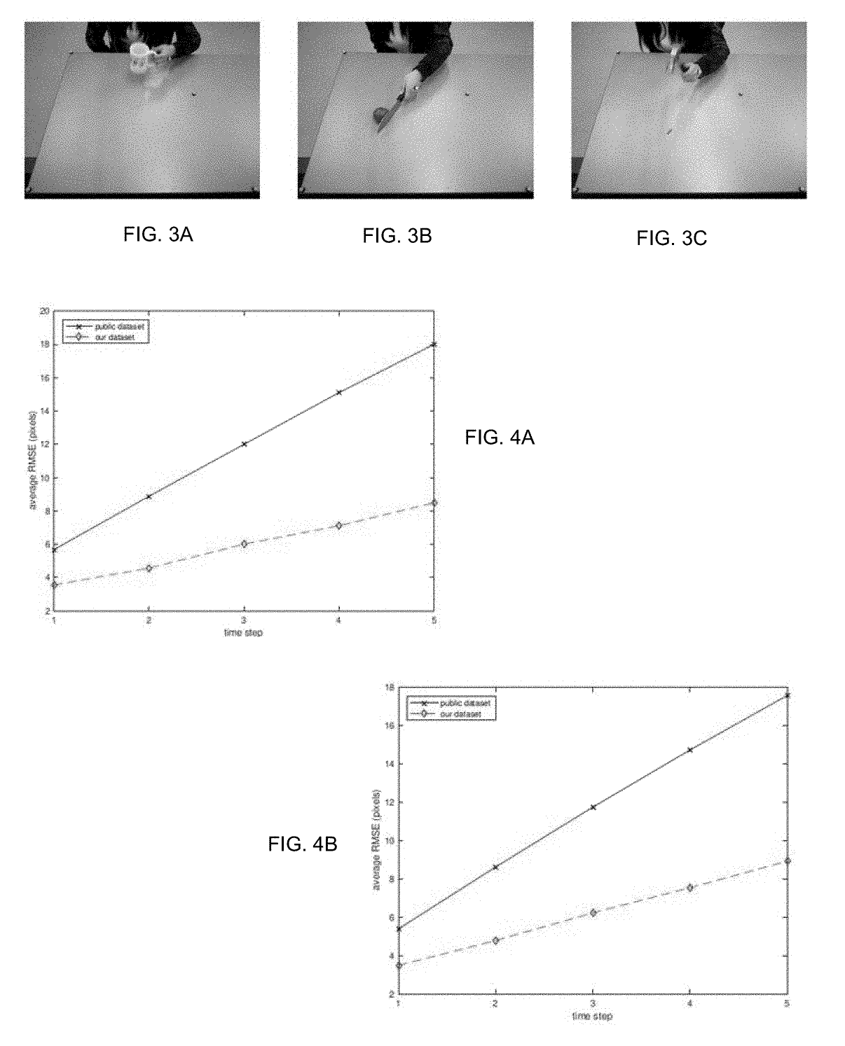

Additionally, to validate that the inventor's vision based movement prediction module is able to provide accurate enough predictions for the robot control module, and further to validate our integrated system in simulation, the aforementioned dataset does not suffice. To enable simulation, the dataset was further complemented with a set of newly collected data. The complementary set records the actual hand position in world coordinate during their manipulation actions through the motion capture system, as well as the camera matrices. The inventors started from several real-world HRI scenarios and designed three actions, each with one target object under manipulation (shown in TABLE II and FIG. 3). For each action object pair, the human subject was asked to repeat the same action five times. The total number of 60 recordings serves as the test bed to 1) further validate the movement prediction module and 2) validate the integration of vision and robot movement planning modules in simulation.

TABLE II
Object-action pairs in the supplemental dataset

| Object | Action |
|---|---|
| cup | drink water |
| knife | cut tomato |
| hammer | pound |

### Experiment I: Visual Movement Prediction

TABLE III
Average RMSE of predicted hand displacements from
one step to five steps in the future (in pixels)

| # of steps | public dataset | our dataset |
|---|---|---|
| (dx1, dy1) | (5.676, 5.395) | (3.559, 3.486) |
| (dx2, dy2) | (8.881, 8.626) | (4.564, 4.790) |
| (dy3) | (11.998, 11.751) | (6.007, 6.233) |
| dy4) | (15.103, 14.735) | (7.113, 7.544) |
| dy5) | (18.005, 17.580) | (8.491, 8.927) |

To evaluate the performance of the movement prediction module, a performance metric was required. Here, the widely accepted performance metric of RMSE was adopted. It is defined in equation (9), where N denotes the total number of testing videos, T denotes the number of frames with each testing video. Here, ŷᵢₜ and yᵢₜ are the predicted value and ground truth value of the hand displacement on the i^{th} video sample at time t respectively. Both ŷᵢₜ and yᵢₜ, as well as the RMSE are measured by the number of pixels. The total number of pixels is determined by the resolution of the video frames (640×480 pixels).

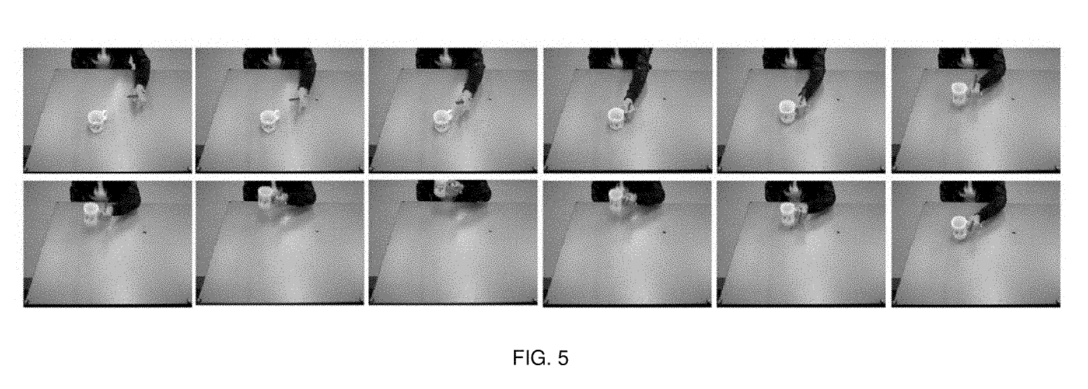

The training and testing protocol we used is leave-one-out cross-validation. On both testing beds, we report the average RMSEs as the performance of the trained models. TABLE III and FIG. 4 show the average RMSE of predicted hand displacements range from one step in the future to five steps in the future. To demonstrate how well our movement prediction module perform, in FIG. 5 we show examples of the prediction outputs, where the orientation and length of the red arrows overlaying on the human hand depict the in-situ hand movement prediction at that specific frame.

From the experimental results, it is worth mentioning the following: 1) our prediction module is able to predict human hand movement within an RMSE of about 18 pixels, which empirically validates our hypothesis (a); 2) with the increasing number of steps to predict, the RMSE tends to increase, which aligns well with our expectation.

### Experiment II: Planning with Prediction

To validate the optimal trajectory generation method, we conducted a simulation test in Virtual Robot Experimentation Platform (V-REP). We set up a scene where the human worker and the robot manipulator worked upon the same table in V-REP environment. The motion capture data, which were recorded in our complementary dataset, were adopted to create the animation of the human hand movement in the scene. We then sent the location data of human right hand and the configuration of UR5 V-REP to MATLAB via a communication API by VREP. We solved the nonlinear optimization problem by fmincon solver with the option of sequential quadratic programming (SQP) algorithm using the MATLAB optimization toolbox. The average time of solving the nonlinear optimization problem is 0.008 seconds, which indicates this optimization formation is capable for real-time implementation. Then the optimized joint position values of the manipulator are forwarded to a V-REP scene, where the simulation is conducted.

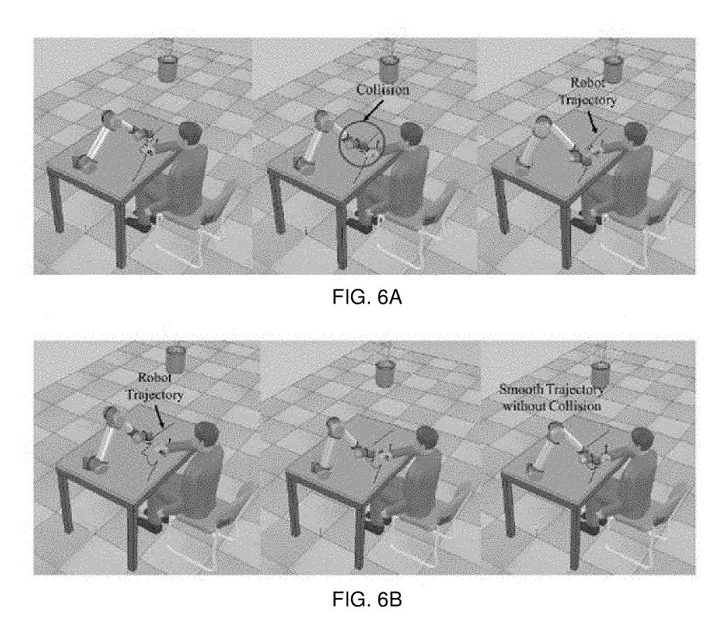

The simulation results are demonstrated in FIGS. 6A and 6B, where the generated trajectories with or without the motion prediction safety constraints are compared. As FIG. 6A indicates, without the motion prediction output from vision module, the trajectory failed to guarantee safety, which leads to a collision between the human hand and the robot end effector. FIG. 6B presents the trajectory generated with the human motion prediction, which presents a detour to ensure adequate safety as well as trajectory smoothness while fulfilling the task at the same time.

The simulation was then extended while substituting the human hand motion data with the second round motion capture data, which contains three scenarios including drinking water, knife cutting and hammer pounding. Every scenario contains 20 trials of motion. If there was no collision between human hand and robot manipulator, the trial was labeled as a safe trial. TABLE IV indicates that the human motion prediction significantly improves safety.

### Experiment III: An Integrated Robotic System

An experiment was conducted with a UR5 manipulator, a host PC and an Xtion PRO LIVE RGBD camera.

TABLE IV
Comparison of safety performance
with or without motion prediction

| Number of safe trial | with prediction | without prediction |
|---|---|---|
| Drink water | 20 | 12 |
| Knife cutting | 20 | 10 |
| Hammer pounding | 20 | 4 |

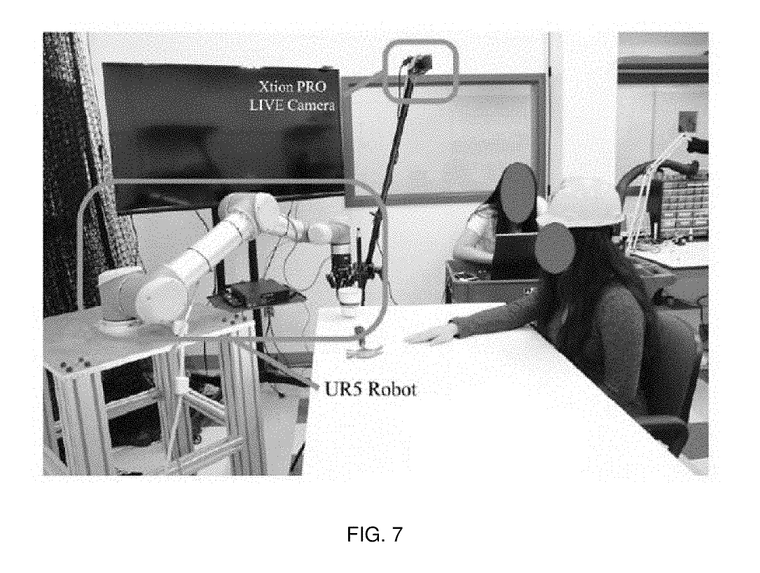

FIG. 7 shows a snapshot of the experimental setup. The human co-worker and the robot arm operated over the same table plane, while the camera had a top-down view of the table for coordinate alignment. Both the UR5 and camera are connected to the host PC, where the ROS core and all the nodes are executed. The optimization problem was implemented with sequential quadratic programming (SQP) solver from scipy optimization toolbox in the UR5Controller node showed in FIG. 2. One optimization problem was solved within 0.01 seconds, which made the real-time trajectory generation possible.

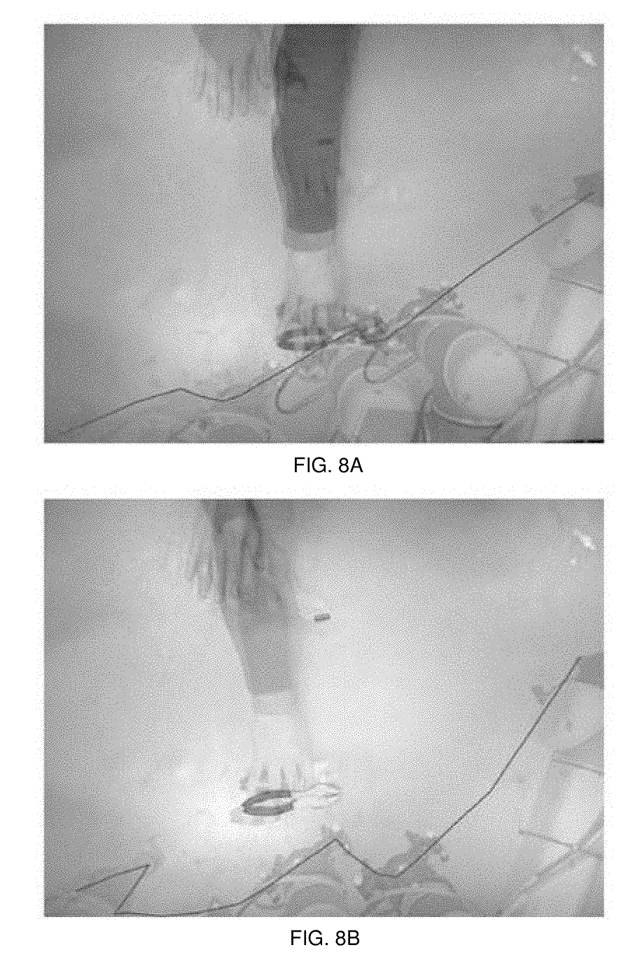

A lab assistant was asked to perform the hammer pounding motion on the table, while the UR5's task is to move diagonally across the table. The original route of the robot to achieve the goal was obstructed by the human pounding motion. FIG. 8B shows the trajectory of the robot end-effector with a solid red line, which demonstrates a successful detour to avoid the human hand with the predicted human motion. While in FIG. 8A, the gripper fails to avoid the human hand without the human motion prediction. This overall integration of the system empirically validates the hypothesis that our system is capable of generating an optimal collision-free trajectory to ensure the safety in HRI with vision-based hand movement prediction.

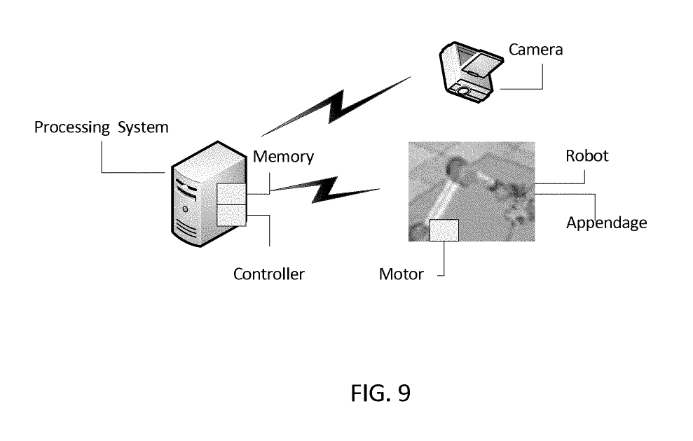

FIG. 9 illustrates a block diagram of the system. The system includes a camera which captures images. A robot includes an appendage which is configured to move and/or manipulate objects. The appendage is coupled to the appendage and is configured to provide power and manipulate movement of the appendage. The system additionally includes a processing system. The processing system includes a controller and a memory. The controller is communicatively coupled with the camera and the robot. The controller can be communicatively coupled with the camera and/or the robot, for example, by a wireless connection or by wired connection. The memory is configured to store instructions executable by the controller. For example, the memory can include instructions, which when executed by the controller, are operable to: receive an image including a human body part captured by the camera; set a boundary around the human body part to track the human body part; determine a predicted motion of the human body part; generate a trajectory of the robot based on the predicted movement of the human body part to avoid collision between the robot and the human body part; and control the robot to move along the trajectory. The processing system can be separate from the robot or camera. In some examples, the processing system can be integrated within the camera and/or the robot. The system can continuously repeat taking and sending an image, for example by taking multiple images or taking a video, to the controller and predict the motion of the human body part. As such, the trajectory of the robot can be updated in real time. To do so, the system can receive another image including the human body part captured by the camera, determine a further predicted motion of the human body part, generate an updated trajectory of the robot based on the further predicted movement of the human body part; and control the robot to move along the updated trajectory.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method comprising:
receiving, by a controller, an image captured by a camera which includes a human body part;
setting, by the controller, a boundary around the human body part to track the human body part;
determining, by the controller, a predicted motion of the human body part;
generating, by the controller, a trajectory of a robot based on the predicted motion of the human body part to avoid collision between the robot and the human body part; and
controlling, by the controller, the robot to move along the trajectory.

2. The method of claim 1, wherein the steps of receiving an image and determining a predicted motion of the human body part are repeated continuously and the trajectory of the robot is updated in real time.

3. The method of claim 1, further comprising:
receiving another image including the human body part captured by the camera,
determining a further predicted motion of the human body part,
generating an updated trajectory of the robot based on the further predicted movement of the human body part; and
controlling the robot to move along the updated trajectory.

4. The method of claim 1, wherein the human body part is tracked by a convolutional neural network (CNN).

5. The method of claim 1, wherein the predicted motion of the human body part is determined by a recurrent neural network (RNN).

6. The method of claim 5, wherein the RNN utilizes a long short-term memory (LSTM) model to determine the predicted motion based on a position of the human body part within the image.

7. The method of claim 1, wherein the trajectory of the robot maintains a predetermined distance from the human body part.

8. The method of claim 1, further comprising:
calibrating coordinates of the image to a Cartesian space from which the robot is operated.

9. A system comprising:
a camera;
a robot;
a controller communicatively coupled with the camera and the robot; and
a memory configured to store instructions executable by the controller, the instructions, when executed, are operable to:
receive an image including a human body part captured by the camera;
set a boundary around the human body part to track the human body part;
determine a predicted motion of the human body part;
generate a trajectory of the robot based on the predicted motion of the human body part to avoid collision between the robot and the human body part; and
control the robot to move along the trajectory.

10. The system of claim 9, wherein the steps to receive an image and determine a predicted motion of the human body part are repeated continuously and the trajectory of the robot is updated in real time.

11. The system of claim 9, wherein after controlling the robot to move along the trajectory, the instructions, when executed by the controller, are further operable to:
receive another image including the human body part captured by the camera,
determine a further predicted motion of the human body part,
generate an updated trajectory of the robot based on the further predicted movement of the human body part; and
control the robot to move along the updated trajectory.

12. The system of claim 9, wherein the human body part is tracked by a convolutional neural network (CNN).

13. The system of claim 9, wherein the predicted motion of the human body part is determined by a recurrent neural network (RNN).

14. The system of claim 13, wherein the RNN utilizes a long short-term memory (LSTM) model to determine the predicted motion based on a position of the human body part within the image.

15. The system of claim 9, wherein the trajectory of the robot maintains a predetermined distance from the human body part.

16. The system of claim 9, wherein the instructions, when executed by the controller, are further operable to:
calibrate coordinates of the image to a Cartesian space from which the robot is operated.

17. A robot comprising:
an appendage;
a motor coupled to the appendage, the motor configured to manipulate movement of the appendage;
a controller coupled with the motor; and
a memory configured to store instructions executable by the controller, the instructions, when executed, are operable to:
receive an image including a human body part captured by a camera;
set a boundary around the human body part to track the human body part;
determine a predicted motion of the human body part;
generate a trajectory of the appendage of the robot based on the predicted motion of the human body part to avoid collision between the robot and the human body part; and
control the motor to move the appendage along the trajectory.

18. The robot of claim 17, wherein the steps to receive an image and determine a predicted motion of the human body part are repeated continuously and the trajectory of the appendage is updated in real time.

19. The robot of claim 17, wherein the human body part is tracked by a convolutional neural network (CNN), and wherein the predicted motion of the human body part is determined by a recurrent neural network (RNN) which utilizes a long short-term memory (LSTM) model to determine the predicted motion based on a position of the human body part within the image.

20. The robot of claim 17, wherein the trajectory of the robot maintains a predetermined distance from the human body part.
